(19) United States
(12) Patent Application Publication
(10) Pub. No.: US 2025/0148747 A1
(43) Pub. Date: May 8, 2025

(54) INFORMATION PROCESSING DEVICE AND INFORMATION PROCESSING METHOD

(71) Applicant: SONY GROUP CORPORATION, TOKYO (JP)

(72) Inventors: KUNIAKI NODA, TOKYO (JP); TAKAYUKI SAKAMOTO, TOKYO (JP)

(21) Appl. No.: 18/835,944

(22) PCT Filed: Jan. 30, 2023
(86) PCT No.: PCT/JP2023/002804

§ 371 Date: Aug. 5, 2024

(30) Foreign Application Priority Data
Feb. 15, 2022 (JP) 2022-021183

(51) Int. Cl. G06V 10/26; G06V 10/764; G06V 20/64

(52) U.S. Cl. CPC G06V 10/26; G06V 10/764; G06V 20/64; G06T 2207/10028

(57) ABSTRACT

The present technology relates to an information processing device and an information processing method that achieve an improvement in accuracy of object detection using a three-dimensional point cloud. The information processing device includes a segmentation unit that executes segmentation of a point cloud including a plurality of ranging points on the basis of a distance between the ranging points to partition the point cloud into a plurality of segments, an object detection unit that executes object detection processing on the basis of a captured image obtained by capturing an image of an observation region where the point cloud has been observed, and a segment correction unit that corrects the segments on the basis of a result of the object detection processing. The present technology is applicable to, for example, an object detection device.

### TECHNICAL FIELD

The present technology relates to an information processing device and an information processing method, and more particularly, to an information processing device and an information processing method that achieve an improvement in accuracy of object detection using a three-dimensional point cloud.

### BACKGROUND ART

There has been proposed a technology for detecting an object of interest by giving pseudo ranging points to a region where the number of ranging points of the object of interest is not enough in a three-dimensional point cloud and executing matching with reference three-dimensional data (see, for example, Patent Document 1).

### CITATION LIST

### Patent Document

Patent Document 1: Japanese Patent Application Laid-Open No. 2018-124973

### SUMMARY OF THE INVENTION

### Problems to be Solved by the Invention

However, for example, in a case where a transparent object is partially clear to cause the front surface and the back surface to be simultaneously observed, a difference in distance value (depth value) between the front surface and the back surface becomes large. In this case, with the technology described in Patent Document 1, there is a possibility that the front surface and the back surface are recognized as regions of different objects although the front surface and the back surface belong to the same object.

The present technology has been made in view of such circumstances, and it is therefore an object of the present technology to achieve an improvement in accuracy of object detection using a three-dimensional point cloud.

### Solutions to Problems

An information processing device according to one aspect of the present technology includes a segmentation unit that executes segmentation of a first point cloud including a plurality of ranging points on the basis of a distance between the ranging points to partition the first point cloud into a plurality of segments, an object detection unit that executes object detection processing on the basis of a captured image obtained by capturing an image of an observation region where the first point cloud has been observed, and a segment correction unit that corrects the segments on the basis of a result of the object detection processing.

An information processing method according to one aspect of the present technology includes executing segmentation of a point cloud including a plurality of ranging points on the basis of a distance between the ranging points to partition the point cloud into a plurality of segments, executing object detection processing on the basis of a captured image obtained by capturing an image of an observation region where the point cloud has been observed, and correcting the segments on the basis of a result of the object detection processing.

According to one aspect of the present technology, segmentation of a point cloud including a plurality of ranging points is executed on the basis of a distance between the ranging points to partition the point cloud into a plurality of segments, object detection processing is executed on the basis of a captured image obtained by capturing an image of an observation region where the point cloud has been observed, and the segments are corrected on the basis of a result of the object detection processing.

### BRIEF DESCRIPTION OF DRAWINGS

FIG. 1 is a block diagram illustrating a configuration example of a known information processing system.

FIG. 2 is a flowchart for describing known object detection processing.

FIG. 3 is a flowchart for describing details of three-dimensional object point cloud segmentation processing.

FIG. 4 is a diagram for describing challenges in known object detection processing.

FIG. 5 is a diagram for describing challenges in the known object detection processing.

FIG. 6 is a block diagram illustrating a first embodiment of an information processing system to which the present technology is applied.

FIG. 7 is a flowchart for describing object detection processing executed by the information processing system in FIG. 6.

FIG. 8 is a diagram for describing the object detection processing in FIG. 7.

FIG. 9 is a block diagram illustrating a second embodiment of the information processing system to which the present technology is applied.

FIG. 10 is a flowchart for describing a first embodiment of object detection processing executed by the information processing system in FIG. 9.

FIG. 11 is a diagram for describing the object detection processing in FIG. 10.

FIG. 12 is a flowchart for describing a second embodiment of the object detection processing executed by the information processing system in FIG. 9.

FIG. 13 is a diagram for describing the object detection processing in FIG. 12.

FIG. 14 is a flowchart for describing a third embodiment of the object detection processing executed by the information processing system in FIG. 9.

FIG. 15 is a diagram for describing the object detection processing in FIG. 14.

FIG. 16 is a flowchart for describing a fourth embodiment of the object detection processing executed by the information processing system in FIG. 9.

FIG. 17 is a diagram for describing a ranging point interpolation method.

FIG. 18 is a diagram for describing a method for detecting a transparent region.

FIG. 19 is a diagram for describing the ranging point interpolation method.

FIG. 20 is a diagram for describing the ranging point interpolation method.

FIG. 21 is a diagram for describing the ranging point interpolation method.

FIG. 22 is a block diagram illustrating a configuration example of a computer.

### MODE FOR CARRYING OUT THE INVENTION

Hereinafter, modes for carrying out the present technology will be described. The description will be given in the following order.
1. Known Object Detection Method
2. First Embodiment of Present Technology
3. Second Embodiment of Present Technology
4. Modifications
5. Others

### 1. Known Object Detection Method

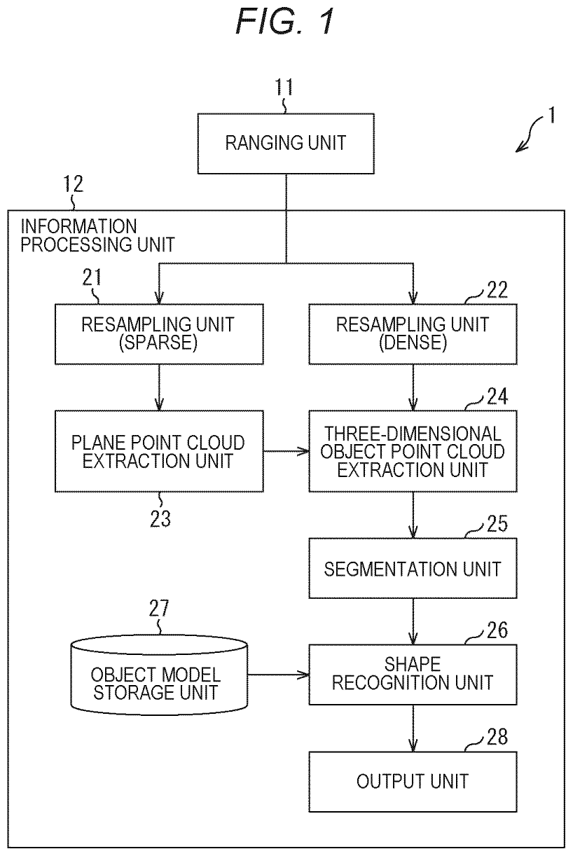

First, a known object detection method will be described with reference to FIGS. 1 to 5.

### <Configuration Example of Known Information Processing System 1>

FIG. 1 illustrates a configuration example of a known information processing system 1.

The information processing system 1 includes a ranging unit 11 and an information processing unit 12.

For example, the ranging unit 11 includes a ranging sensor such as a light detection and ranging (LiDAR) sensor, a depth camera, or a time of flight (ToF) sensor. The ranging unit 11 executes sensing of a predetermined observation region (sensing region) to generate a range image indicating a distance value (depth value) of each point in the observation region (hereinafter, referred to as ranging point). The ranging unit 11 generates a point cloud indicating a three-dimensional distribution of each ranging point on the basis of the range image. The ranging unit 11 supplies point cloud data indicating the generated point cloud to the information processing unit 12.

The information processing unit 12 executes processing of detecting an object in the observation region on the basis of the point cloud data. The information processing unit 12 includes a resampling unit 21, a resampling unit 22, a plane point cloud extraction unit 23, a three-dimensional object point cloud extraction unit 24, a segmentation unit 25, a shape recognition unit 26, an object model storage unit 27, and an output unit 28.

The resampling unit 21 executes resampling of the point cloud data supplied from the ranging unit 11 to reduce the number of ranging points from the point cloud. The resampling unit 21 supplies, to the plane point cloud extraction unit 23, sparse point cloud data indicating the point cloud obtained as a result of the resampling (hereinafter, referred to as sparse point cloud).

The resampling unit 22 executes resampling of the point cloud data supplied from the ranging unit 11 to reduce the number of ranging points from the point cloud. The resampling unit 22 supplies, to the three-dimensional object point cloud extraction unit 24, dense point cloud data indicating a point cloud obtained as a result of the resampling (hereinafter, referred to as dense point cloud).

Note that the resampling unit 21 resamples the point cloud more sparsely than the resampling unit 22. In other words, the resampling unit 22 resamples the point cloud more densely than the resampling unit 21. Therefore, the resampling unit 21 thins out the point cloud more aggressively than the resampling unit 22, so that the sparse point cloud obtained as a result of the resampling is lower in density than the dense point cloud. In other words, the resampling unit 22 thins out the point cloud more modestly than the resampling unit 21, so that the dense point cloud obtained as a result of the resampling is higher in density than the sparse point cloud.

Note that, as will be described later, the sparse point cloud is used in processing of detecting a plane such as a floor or a table, and a region for the detection processing is larger than a region for processing of detecting a three-dimensional object using the dense point cloud. Therefore, the sparse point cloud can be made lower in point cloud density than the dense point cloud.

The plane point cloud extraction unit 23 extracts, from the sparse point cloud, ranging points corresponding to a plane such as a floor or a desk in the observation region. The plane point cloud extraction unit 23 supplies, to the three-dimensional object point cloud extraction unit 24, plane point cloud data indicating a point cloud including the extracted ranging points (hereinafter, referred to as plane point cloud).

The three-dimensional object point cloud extraction unit 24 extracts, from the dense point cloud, ranging points corresponding to a three-dimensional object in the observation region on the basis of the plane point cloud. The three-dimensional object point cloud extraction unit 24 supplies, to the segmentation unit 25, three-dimensional object point cloud data indicating a point cloud including the extracted ranging points (hereinafter, referred to as three-dimensional object point cloud).

The segmentation unit 25 executes segmentation of the three-dimensional object point cloud on the basis of a distance between the ranging points to partition the three-dimensional object point cloud into segments for each object. The segmentation unit 25 supplies, to the shape recognition unit 26, three-dimensional object point cloud data containing segment information indicating a segment to which each ranging point belongs.

The shape recognition unit 26 recognizes a shape of the object corresponding to each segment of the three-dimensional object point cloud on the basis of object shape models prestored in the object model storage unit 27. The shape recognition unit 26 supplies, to the output unit 28, information indicating an object detection result obtained by recognizing the shape of the object (hereinafter, referred to as object detection information).

The object model storage unit 27 stores object shape models of various shapes such as a sphere, a cylinder, and a prism. Furthermore, the object model storage unit 27 stores basic shape information indicating a basic shape type for each type of object. For example, the basic shape of a ball is a sphere, the basic shape of a bottle is a cylinder, and the basic shape of a box is a quadrangular prism.

The output unit 28 outputs the object detection information to the outside.

### <Object Detection Processing>

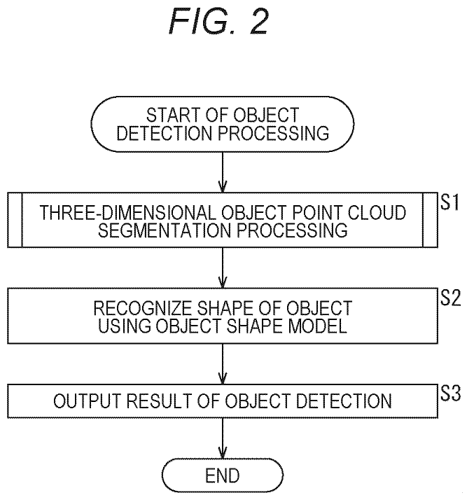

Next, object detection processing executed by the information processing system 1 will be described with reference to the flowchart in FIG. 2.

In step S1, the information processing system 1 executes three-dimensional object point cloud segmentation processing.

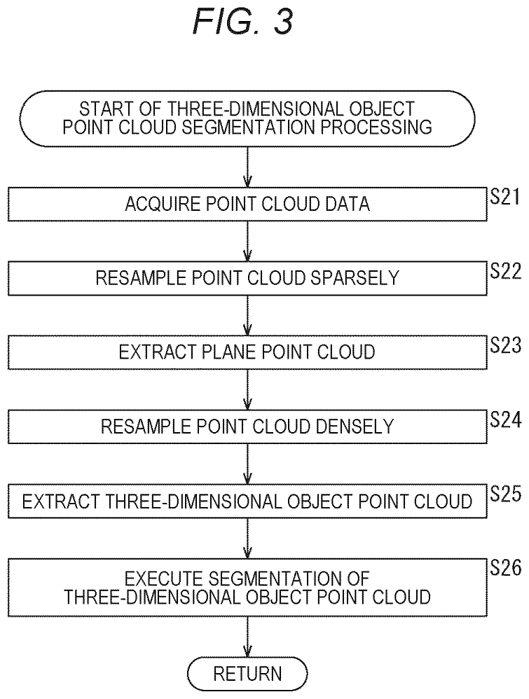

Here, details of the three-dimensional object point cloud segmentation processing will be described with reference to the flowchart in FIG. 3.

In step S21, the ranging unit 11 acquires point cloud data. Specifically, the ranging unit 11 executes sensing over the observation region to generate a range image indicating a distance value of each ranging point in the observation region. The ranging unit 11 generates a point cloud indicating a three-dimensional distribution of each ranging point on the basis of the range image, and supplies point cloud data indicating the generated point cloud to the resampling unit 21 and the resampling unit 22.

In step S22, the resampling unit 21 resamples the point cloud sparsely. The resampling unit 21 supplies, to the plane point cloud extraction unit 23, sparse point cloud data indicating a sparse point cloud obtained as a result of the resampling.

In step S23, the plane point cloud extraction unit 23 extracts a plane point cloud. Specifically, the plane point cloud extraction unit 23 estimates a plane such as a floor surface or a table surface on the basis of the sparse point cloud. The plane point cloud extraction unit 23 extracts ranging points corresponding to the estimated plane from the sparse point cloud. The plane point cloud extraction unit 23 supplies, to the three-dimensional object point cloud extraction unit 24, plane point cloud data indicating a plane point cloud including the extracted ranging points.

In step S24, the resampling unit 22 resamples the point cloud densely. The resampling unit 22 supplies, to the three-dimensional object point cloud extraction unit 24, dense point cloud data indicating a dense point cloud obtained as a result of the resampling.

In step S25, the three-dimensional object point cloud extraction unit 24 extracts a three-dimensional object point cloud. Specifically, the three-dimensional object point cloud extraction unit 24 removes ranging points included in the plane point cloud from the dense point cloud to extract ranging points corresponding to a three-dimensional object in the observation region. The three-dimensional object point cloud extraction unit 24 supplies, to the segmentation unit 25, three-dimensional object point cloud data indicating a three-dimensional object point cloud including the extracted ranging points.

In step S26, the segmentation unit 25 executes segmentation of the three-dimensional object point cloud. For example, the segmentation unit 25 applies Euclidean clustering to the three-dimensional object point cloud. As a result, nearby ranging points are grouped together (gathered in a cluster) on the basis of the distance value of each ranging point, and the three-dimensional object point cloud is partitioned into one or more segments for each three-dimensional object. Each segment includes ranging points corresponding to each object. The segmentation unit 25 supplies, to the shape recognition unit 26, three-dimensional object point cloud data containing segment information indicating a segment to which each ranging point belongs.

Then, the three-dimensional object point cloud segmentation processing ends.

Returning to FIG. 2, in step S2, the shape recognition unit 26 recognizes the shape of an object using the object shape models. Specifically, the shape recognition unit 26 executes shape fitting for each segment of the three-dimensional object point cloud. That is, the shape recognition unit 26 sequentially applies the plurality of object shape models prestored in the object model storage unit 27 to each segment of the three-dimensional object point cloud to select an object shape model fitted with the smallest error. As a result, the shape recognition unit 124 recognizes the shape, position, orientation, and size of the object corresponding to each segment of the three-dimensional object point cloud.

In step S3, the information processing system 1 outputs an object detection result. Specifically, the shape recognition unit 26 supplies, to the output unit 28, object detection information indicating the type of the object shape model fitted to each segment and the position, orientation, and size of the object.

The output unit 28 outputs the object detection information to the outside.

Then, the object detection processing ends.

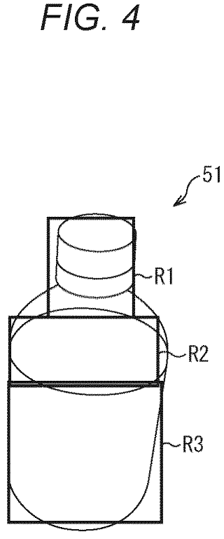

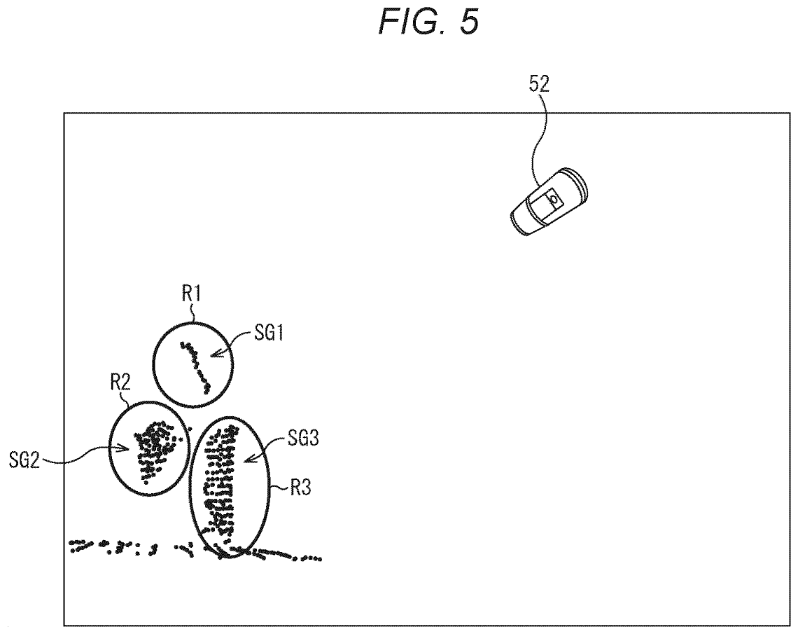

Here, challenges in a case where the object detection processing in FIG. 2 is executed on an object including a transparent portion will be described with reference to FIGS. 4 and 5.

FIG. 4 is a schematic view of a plastic bottle 51. FIG. 5 schematically illustrates a result of segmentation executed on a point cloud corresponding to the plastic bottle 51 in FIG. 4.

A region R1 in FIG. 5 mainly includes ranging points corresponding to a cap of the plastic bottle 51. A region R2 mainly includes ranging points corresponding to a back surface of a label seen through the transparent portion of the plastic bottle 51. A region R3 mainly includes ranging points corresponding to a front surface of the label of the plastic bottle 51.

In this case, as viewed from a ranging sensor 52 included in the ranging unit 11, a distance between the point cloud in the region R1 and the point cloud in the region R2 is large. Furthermore, as viewed from the ranging sensor 52, a distance between the point cloud in the region R2 and the point cloud in the region R3 is large. Therefore, spatial continuity is lost among the point clouds, and the point cloud in the regions R1 to R3 is excessively partitioned into different segments SG1 to SG3 as point clouds corresponding to different objects in the process of step S26 in FIG. 3. As a result, there is a possibility that the plastic bottle 51 is detected as three different objects on the basis of the point cloud in each of the regions R1 to R3, for example.

On the other hand, the present technology enables accurate detection of an object including a transparent portion and a specularly reflective portion, for example.

### 2. First Embodiment of Present Technology

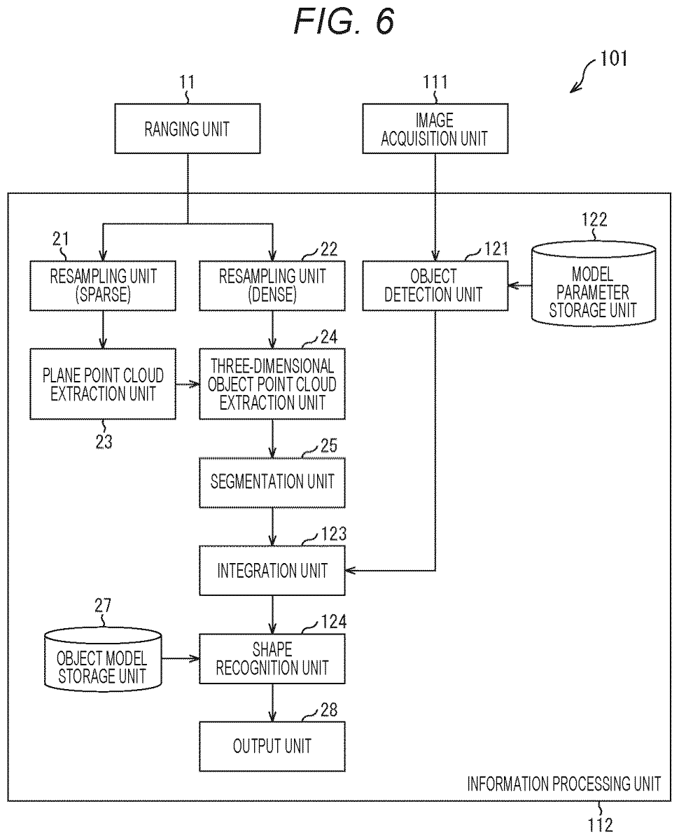

Next, a first embodiment of the present technology will be described with reference to FIGS. 6 to 8.

### <Configuration Example of Information Processing System 101>

FIG. 6 illustrates a configuration example of an information processing system 101 corresponding to the first embodiment of the information processing system to which the present technology is applied. Note that, in the drawing, portions corresponding to those of the information processing system 1 in FIG. 1 are denoted by the same reference signs, and a description thereof will be omitted as appropriate.

The information processing system 101 is identical to the information processing system 1 in that the ranging unit 11 is included. On the other hand, the information processing system 101 is different from the information processing system 1 in that an image acquisition unit 111 is additionally included, and an information processing unit 112 is included instead of the information processing unit 12.

The information processing unit 112 is identical to the information processing unit 12 in that the resampling unit 21, the resampling unit 22, the plane point cloud extraction unit 23, the three-dimensional object point cloud extraction unit 24, the segmentation unit 25, the object model storage unit 27, and the output unit 28 are included. On the other hand, the information processing unit 112 is different from the information processing unit 12 in that an object detection unit 121, a model parameter storage unit 122, and an integration unit 123 are additionally included, and a shape recognition unit 124 is provided instead of the shape recognition unit 26.

The image acquisition unit 111 includes a camera. The image acquisition unit 111 supplies, to the object detection unit 121, captured image data indicating a captured image obtained by capturing an image of the observation region.

Note that a sensing range of the ranging unit 11 and an imaging range of the image acquisition unit 111 need not necessarily coincide exactly with each other.

The object detection unit 121 executes processing of detecting an object in the captured image by a method based on predetermined image recognition using model parameters stored in the model parameter storage unit 122. The object detection unit 121 supplies, to the integration unit 123, object detection information indicating the result of object detection.

The model parameter storage unit 122 stores various model parameters used for the object detection processing.

The integration unit 123 integrates the result of segmentation of the three-dimensional object point cloud executed by the segmentation unit 25 and the result of object detection executed by the object detection unit 121. The integration unit 123 supplies, to the shape recognition unit 124, information indicating the result of integrating the result of segmentation of the three-dimensional object point cloud and the result of object detection.

The shape recognition unit 124 recognizes the shape of the object corresponding to each segment of the three-dimensional object point cloud on the basis of the result of integrating the result of segmentation of the three-dimensional object point cloud and the result of object detection and the object shape models prestored in the object model storage unit 27. The shape recognition unit 124 supplies, to the output unit 28, object detection information indicating an object detection result obtained by recognizing the shape of the object.

### <Object Detection Processing>

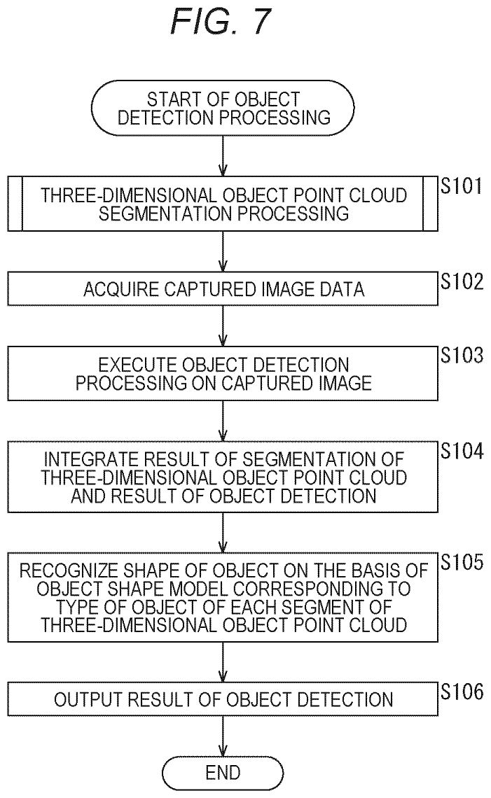

Next, object detection processing executed by the information processing system 101 will be described with reference to the flowchart in FIG. 7.

In step S101, three-dimensional object point cloud segmentation processing is executed in a manner similar to the process of step S1 in FIG. 2.

In step S102, the image acquisition unit 111 acquires captured image data. Specifically, the image acquisition unit 111 captures the image of the observation region, and supplies, to the object detection unit 121, resultant captured image data.

In step S103, the object detection unit 121 executes object detection processing on the captured image. Specifically, the object detection unit 121 executes, using the model parameters stored in the model parameter storage unit 122, the object detection processing on the captured image by a method based on predetermined image recognition. For example, the object detection unit 121 detects each object region where an object appears in the captured image, and recognizes the type of the object in each object region.

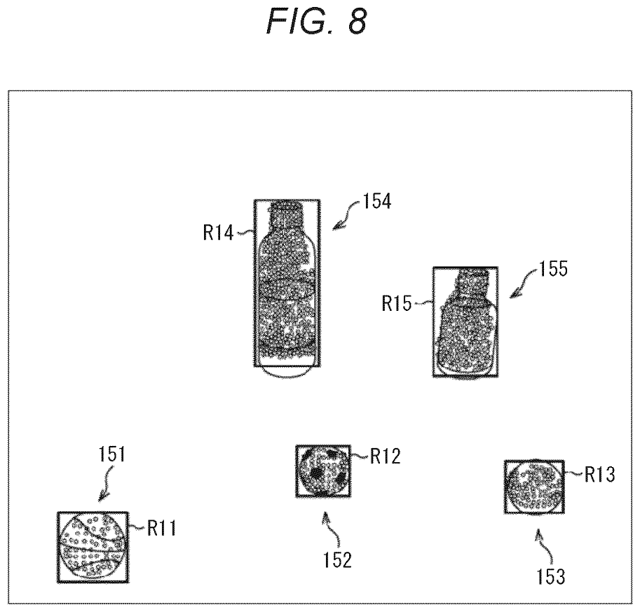

For example, as illustrated in FIG. 8, in the captured image, an object region R11 where a ball 151 appears, an object region R12 where a ball 152 appears, an object region R13 where a ball 153 appears, an object region R14 where a plastic bottle 154 appears, and an object region R15 where a plastic bottle 155 appears are detected. Furthermore, the type of the objects appearing in the object region R11 to the object region R13 is recognized as a ball, and the type of the objects appearing in the object region R14 and the object region R15 is recognized as a plastic bottle.

The object detection unit 121 supplies, to the integration unit 123, captured image data containing object detection information indicating the shape, size, and position of each object region and the type of the object appearing in each object region.

In step S104, the integration unit 123 integrates the result of segmentation of the three-dimensional object point cloud and the result of object detection. Specifically, the integration unit 123 assigns, to each segment of the three-dimensional object point cloud, object type information indicating the type of the object recognized by the object detection unit 121.

For example, object type information indicating that the type of the object is a ball is assigned to the point cloud segment in the object region R11 in FIG. 8. Object type information indicating that the type of the object is a ball is assigned to the point cloud segment in the object region R12. Object type information indicating that the type of the object is a ball is assigned to the point cloud segment in the object region R13. Object type information indicating that the type of the object is a plastic bottle is assigned to the point cloud segment in the object region R14. Object type information indicating that the type of the object is a plastic bottle is assigned to the point cloud segment in the object region R15.

The integration unit 123 supplies, to the shape recognition unit 124, three-dimensional object point cloud data containing segment information including the object type information.

In step S105, the shape recognition unit 124 recognizes the shape of the object using the object shape model corresponding to the type of the object of each segment of the three-dimensional object point cloud. Specifically, the shape recognition unit 124 reads, from the object model storage unit 27, object shape models for the object indicated by the object type information assigned to the segment of the three-dimensional object point cloud for shape recognition. The shape recognition unit 124 executes shape fitting on the segment on the basis of the read object shape models. As a result, the shape recognition unit 124 recognizes the shape, position, orientation, and size of the object corresponding to the segment.

The shape recognition unit 124 executes similar processing on each segment of the three-dimensional object point cloud to recognize the shape, position, orientation, and size of the object corresponding to each segment.

In step S106, the object detection result is output in a manner similar to the process of step S3 in FIG. 2.

Then, the object detection processing ends.

As described above, the type of the object corresponding to each segment of the three-dimensional object point cloud is recognized, and, on the basis of the recognition result, the shape of the object is recognized. This configuration improves accuracy of object detection in a three-dimensional object point cloud.

### 3. Second Embodiment of Present Technology

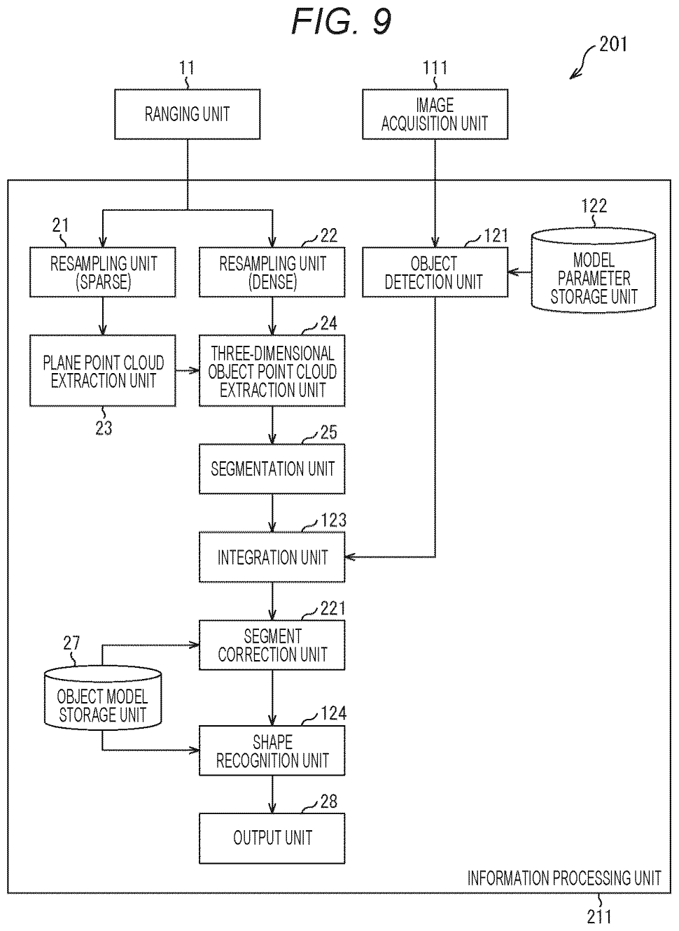

Next, a second embodiment of the present technology will be described with reference to FIGS. 9 to 21.

### <Configuration Example of Information Processing System 201>

FIG. 9 illustrates a configuration example of an information processing system 201 corresponding to the second embodiment of the information processing system to which the present technology is applied. Note that, in the drawing, portions corresponding to those of the information processing system 101 in FIG. 6 are denoted by the same reference signs, and a description thereof will be omitted as appropriate.

The information processing system 201 is identical to the information processing system 101 in that the ranging unit 11 and the image acquisition unit 111 are included. On the other hand, the information processing system 201 is different from the information processing system 101 in that an information processing unit 211 is provided instead of the information processing unit 112.

The information processing unit 211 is identical to the information processing unit 112 in that the resampling unit 21, the resampling unit 22, the plane point cloud extraction unit 23, the three-dimensional object point cloud extraction unit 24, the segmentation unit 25, the object model storage unit 27, the output unit 28, the object detection unit 121, the model parameter storage unit 122, the integration unit 123, and the shape recognition unit 124 are included. On the other hand, the information processing unit 211 is different from the information processing unit 112 in that a segment correction unit 221 is additionally included.

The segment correction unit 221 corrects the segment of the three-dimensional object point cloud on the basis of the result of integrating the result of segmentation of the three-dimensional object point cloud and the result of object detection using, as necessary, the object shape models stored in the object model storage unit 27. The segment correction unit 221 supplies, to the shape recognition unit 124, three-dimensional object point cloud data containing the corrected segment information.

### First Embodiment of Object Detection Processing

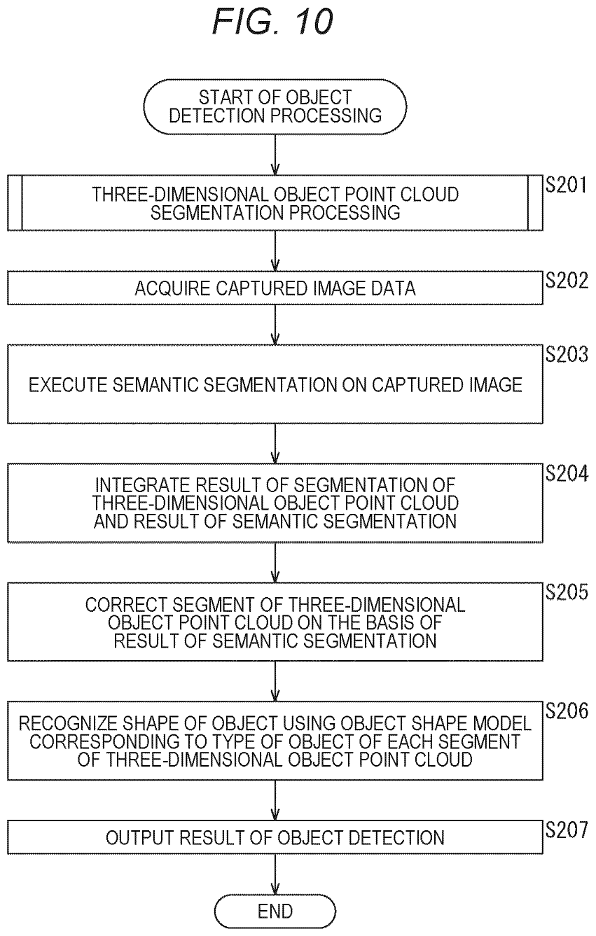

Next, a first embodiment of the object detection processing executed by the information processing system 201 will be described with reference to the flowchart in FIG. 10.

In steps S201 and S202, processes similar to steps S101 and S102 in FIG. 7 are executed.

In step S203, the object detection unit 121 executes semantic segmentation on the captured image using the model parameters stored in the model parameter storage unit 122.

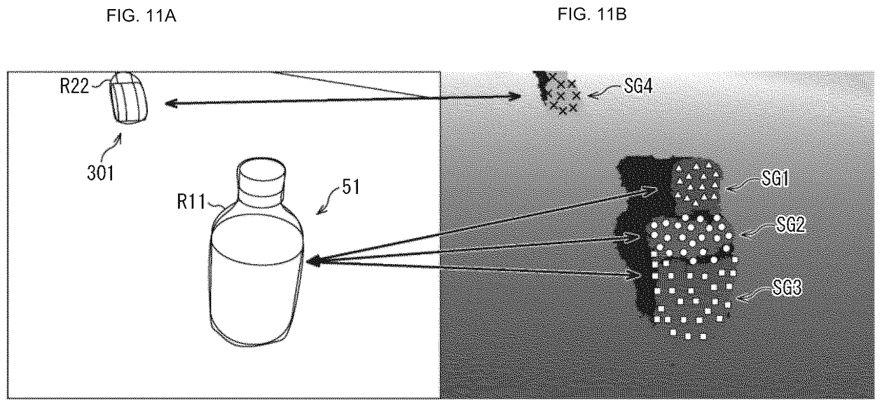

As a result, the object region where each object appears in the captured image is segmented on a pixel-by-pixel basis, and the type of the object in each object region is recognized. For example, as illustrated in A of FIG. 11, an object region R21 where the plastic bottle 51 appears and an object region R22 where a tire 202 appears are detected on a pixel-by-pixel basis. Furthermore, the type of the object in the object region R21 is recognized as a plastic bottle, and the object in the object region R22 is recognized as a tire.

Note that the plastic bottle 51 in A of FIG. 11 is the same as illustrated in FIGS. 4 and 5.

Furthermore, B of FIG. 11 illustrates an example of a result of segmentation of the three-dimensional object point cloud. In this drawing, each ranging point of the three-dimensional object point cloud is superimposed on the range image used to generate the three-dimensional object point cloud. Furthermore, each ranging point is indicated by a different type of point for each segment. The three-dimensional object point cloud corresponding to the plastic bottle 51 is partitioned into segments SG1 to SG3 in a manner similar to the example in FIG. 5. The point cloud corresponding to the tire 202 belongs to one segment SG4.

The object detection unit 121 supplies, to the integration unit 123, captured image data containing object type information indicating the type of the object assigned to each pixel of the captured image.

In step S204, the integration unit 123 integrates the result of segmentation of the three-dimensional object point cloud and the result of object detection. Specifically, the integration unit 123 projects each ranging point of the three-dimensional object point cloud onto the captured image on a segment-by-segment basis.

For example, each ranging point of the three-dimensional object point cloud in B of FIG. 11 is projected, for each segment, onto a corresponding position in the captured image in A of FIG. 11.

The integration unit 123 assigns, to each ranging point of the three-dimensional object point cloud projected onto the captured image, the object type information assigned to the projected object region. The integration unit 123 supplies, to the segment correction unit 221, three-dimensional object point cloud data containing segment information including the object type information.

In step S205, the segment correction unit 221 corrects the segment of the three-dimensional object point cloud on the basis of the result of the semantic segmentation. Specifically, the integration unit 123 re-groups each ranging point on the basis of the object type information. Accordingly, the ranging points corresponding to the same object are grouped into the same segment. As a result, in a case where a point cloud corresponding to the same object has been partitioned into different segments, the segments are grouped into the same segment.

For example, the three segments SG1 to SG3 corresponding to the plastic bottle 51 in B of FIG. 11 are grouped into one segment.

The segment correction unit 221 assigns the object type information indicating the type of the object recognized by the semantic segmentation to each corrected segment of the three-dimensional object point cloud. The segment correction unit 221 supplies, to the shape recognition unit 124, three-dimensional object point cloud data containing the corrected segment information. In steps S206 and S207, processes similar to steps S105 and S106 in FIG. 7 are executed.

Then, the object detection processing ends.

As described above, the object region and the type of the object in the captured image are detected on a pixel-by-pixel basis by the semantic segmentation, and the segments of the three-dimensional object point cloud are re-grouped on the basis of the detection result. As a result, the three-dimensional object point cloud is accurately partitioned into a plurality of segments for each object, so that the object detection accuracy improves.

The semantic segmentation, however, is highly computationally intensive. It is therefore difficult for, for example, a mobile robot or the like that does not have enough calculation resources to execute processing in real time particularly in a case where the semantic segmentation is executed on a high-resolution image.

On the other hand, in a case where enough calculation resources are not available, it is effective to use object detection processing of outputting a rectangular bounding box as an object detection result, for example. That is, it is effective to use object detection processing of detecting an object region on a bounding box-by-bounding box basis. The object detection processing of detecting an object region on a bounding box-by-bounding box basis is described in detail in, for example, “J. Redmon, S. Divvala, R. Girshick, and A. Farhadi. You Only Look Once: Unified, Real-Time Object Detection, In Proceedings of the IEEE Conference on Computer Vision and Pattern Recognition (CVPR), 2016.” (hereinafter, referred to as Non-Patent Document 1).

In the second embodiment of the object detection processing, the object detection processing of detecting an object region on a bounding box-by-bounding box basis is used instead of the semantic segmentation.

### Second Embodiment of Object Detection Processing

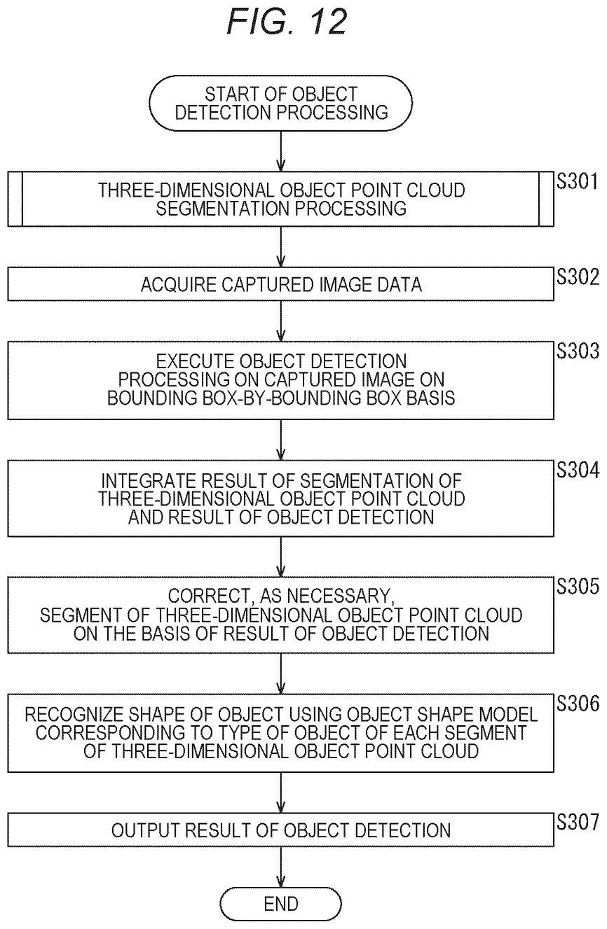

The second embodiment of the object detection processing executed by the information processing system 201 will be described below with reference to the flowchart in FIG. 12.

In steps S301 and S302, processes similar to steps S101 and S102 in FIG. 7 are executed.

In step S303, the object detection unit 121 executes the object detection processing on a bounding box-by-bounding box basis on the captured image using the model parameters stored in the model parameter storage unit 122. For example, the object detection unit 121 executes the object detection processing on the captured image using the method described in Non-Patent Document 1 described above.

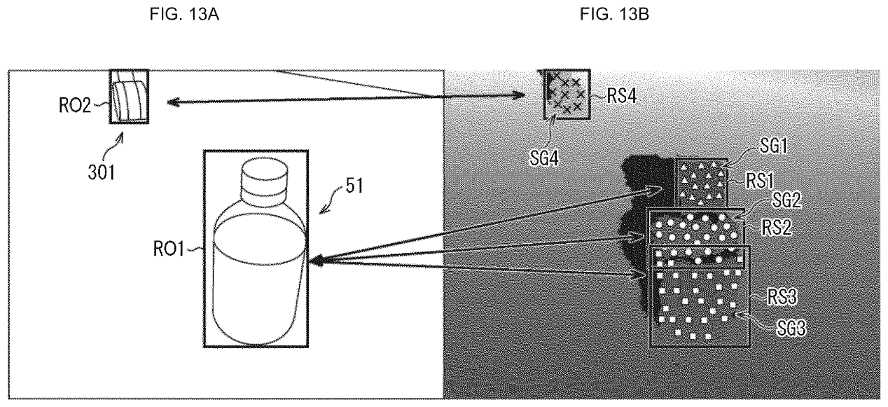

A of FIG. 13 illustrates an example of a result of the object detection processing. For example, a rectangular object region RO1 including the plastic bottle 51 and a rectangular object region RO2 including a tire 301 are detected. Furthermore, the type of the object in the object region RO1 is recognized as a plastic bottle, and type of the object in the object region RO2 is recognized as a tire.

The object detection unit 121 supplies, to the integration unit 123, captured image data containing object detection information indicating the size and position of the object region and the type of the object in the object region.

In step S304, the integration unit 123 integrates the result of the segmentation of the three-dimensional object point cloud and the result of object detection. Specifically, the integration unit 123 projects each ranging point of the three-dimensional object point cloud onto the captured image on a segment-by-segment basis.

Next, the integration unit 123 evaluates a correspondence between the object region and the rectangular segment region surrounding each segment of the three-dimensional object point cloud projected onto the captured image on the basis of coincidence between the object region and the rectangular segment region. Specifically, the integration unit 123 calculates an evaluation index FAij indicating a degree of coincidence between an object region ROi and a segment region RSj using the following Formula (1). The evaluation index FAij indicates intersection over union (IoU) between the object region ROi and the segment region RSj.

$$\begin{matrix}[ Math . 1 ] & \\ FAij = \frac{R Oi ⋂ RSj}{ROi ⋃ RSj} & ( 1 )\end{matrix}$$

In a case where the evaluation index FAij is greater than a predetermined threshold FAth, the integration unit 123 determines that the object region ROi and the segment region RSj correspond on a one-to-one basis. In other words, in a case where the evaluation index FAij is greater than the predetermined threshold FAth, the integration unit 123 determines that the segment corresponding to the segment region RSj corresponds to, on a one-to-one basis, the object in the object region ROi.

On the other hand, in a case where the evaluation index FAij is less than or equal to the predetermined threshold FAth, the integration unit 123 calculates an evaluation index FBij indicating the degree of coincidence between the object region ROi and the segment region RSj using the following Formula (2).

$$\begin{matrix}[ Math . 2 ] & \\ FBij = \frac{ROi ⋂ RSj}{RSj} & ( 2 )\end{matrix}$$

According to Formula (2), even if there is a margin in the coincidence between the object region ROi and the segment region RSj, whether or not the segment region RSj coincides with the object region ROi at a certain ratio or more is evaluated.

In a case where the evaluation index FBij is greater than a predetermined threshold FBth, the integration unit 123 determines that the segment region RSj corresponds to the object region ROi. In other words, in a case where the evaluation index FBij is greater than the predetermined threshold FBth, the integration unit 123 determines that the segment corresponding to the segment region RSj corresponds to the object in the object region ROi.

On the other hand, in a case where the evaluation index FBij is less than or equal to the predetermined threshold FBth, the integration unit 123 determines that the segment region RSj does not correspond to the object region ROi.

For example, B of FIG. 13 illustrates an example of a case where segment regions RS1 to RS4 correspond to the segments SG1 to SG4.

For example, the segment regions RS1 to RS3 are determined to correspond to the object region RO1 surrounding the plastic bottle 51 in A of FIG. 13. In other words, the segments SG1 to SG3 in the segment regions RS1 to RS3 are determined to correspond to the plastic bottle 51 in the object region RO1.

The segment region RS4 is determined to correspond to the object region RO2 surrounding the tire 301 in A of FIG. 13. In other words, the segment SG4 in the segment region RS4 is determined to correspond to the tire 301 in the object region RO2.

The integration unit 123 assigns, to each segment of the three-dimensional object point cloud, object type information indicating the type of the corresponding object. The integration unit 123 supplies, to the segment correction unit 221, three-dimensional object point cloud data containing segment information including the object type information.

In step S305, the segment correction unit 221 corrects, as necessary, the segment of the three-dimensional object point cloud on the basis of the object detection result. Specifically, in a case where there is a plurality of segments determined to correspond to the same object region, the integration unit 123 re-groups the plurality of segments into one segment. As a result, in a case where a point cloud corresponding to the same object has been partitioned into different segments, the segments are grouped into the same segment.

For example, as illustrated in B of FIG. 13, in a case where the point cloud corresponding to the plastic bottle 51 is partitioned into the segments SG1 to SG3, the segments SG1 to SG3 are grouped into one segment.

Specifically, the integration unit 123 assigns, to each corrected segment of the three-dimensional object point cloud, object type information indicating the type of the object recognized by the object detection processing. The integration unit 123 supplies, to the shape recognition unit 124, three-dimensional object point cloud data containing the updated segment information.

In steps S306 and S307, processes similar to steps S105 and S106 in FIG. 7 are executed.

Then, the object detection processing ends.

As described above, it is possible to improve the accuracy of the segment of the three-dimensional object point cloud using the object detection processing lighter in load than the semantic segmentation.

However, in a case where the shape of the object does not perfectly match the rectangular object region, there is a possibility that an object different from a target object of the object region (hereinafter, referred to as object of interest) enters the object region, for example. For example, there is a case where an object located behind the object of interest enters the object region. In this case, for example, there is a possibility that, in the process of step S305 in FIG. 12, the ranging points corresponding to the different object are grouped into the segment of the ranging points corresponding to the object of interest.

On the other hand, in a third embodiment of the object detection processing, a geometric constraint condition is applied to the correction of the segment of the three-dimensional object point cloud.

### Third Embodiment of Object Detection Processing

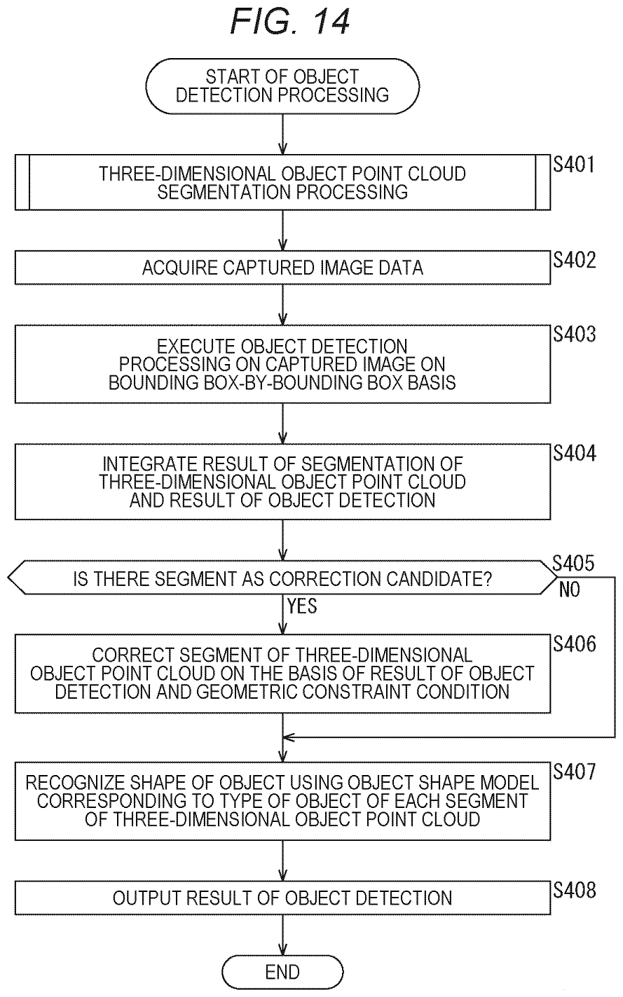

The third embodiment of the object detection processing executed by the information processing system 201 will be described below with reference to the flowchart in FIG. 14.

In steps S401 to S404, processes similar to steps S301 to S304 in FIG. 12 are executed.

In step S405, the segment correction unit 221 determines whether or not there is a segment as a correction candidate. As a result of the process of step S404, in a case where a plurality of segments corresponds to the same object region, the segment correction unit 221 extracts the plurality of segments as a correction candidate. Then, the segment correction unit 221 determines that there is a segment as a correction candidate, and the processing proceeds to step S406.

In step S406, the segment correction unit 221 corrects the segment of the three-dimensional object point cloud on the basis of the object detection result and the geometric constraint condition. The segment correction unit 221 reads, from the object model storage unit 27, object shape models of the basic shape corresponding to the type of the object in the object region corresponding to each segment of the correction candidate. The segment correction unit 221 executes shape fitting on each segment of the correction candidate using the read object shape models. The segment correction unit 221 re-groups, as necessary, the segments on the basis of the result of the shape fitting.

For example, in a case where the basic shape of the object corresponding to the segment of the correction candidate is a sphere, the segment correction unit 221 executes sphere fitting on each segment to obtain a shape parameter of each segment. This shape parameter includes the center and radius of the sphere. For example, in a case where there is a plurality of segments each having the obtained center of the sphere within a predetermined distance range, the segment correction unit 221 re-groups the plurality of segments into one segment.

For example, in a case where the basic shape of the object corresponding to the segment of the correction candidate is a cylinder, the segment correction unit 221 executes cylinder fitting on each segment to obtain a shape parameter of each segment. This shape parameter includes the center, radius, height, and center line direction of the cylinder. For example, in a case where there is a plurality of segments each having an angle of the obtained center line direction of the cylinder within a predetermined range, the segment correction unit 221 re-groups the plurality of segments into one segment.

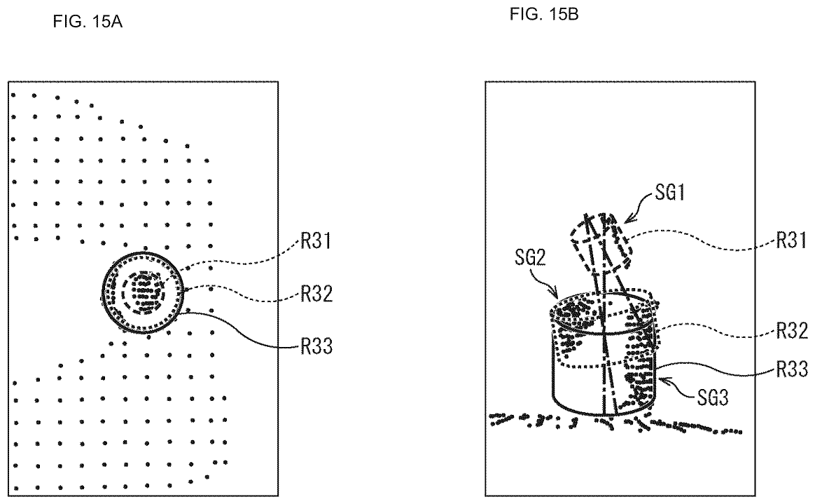

For example, FIG. 15 illustrates an example of a result of cylinder fitting on segments SG1 to SG3 corresponding to the plastic bottle 51. That is, an example where cylinder regions R31 to R33 correspond to the segments SG1 to SG3 is illustrated. A of FIG. 15 is a diagram illustrating the regions R31 to R33 as viewed from above, and B of FIG. 15 is a diagram illustrating the regions R31 to R33 as viewed from the side.

In this case, for example, the angles of the center lines of the regions R31 to R33 are within the predetermined range, and the segments SG1 to SG3 are grouped into one segment.

For example, in a case where the basic shape of the object corresponding to the segment of the correction candidate is a polygonal prism (for example, a triangular prism, a quadrangular prism, a pentagonal prism, or the like), the segment correction unit 221 executes polygonal prism fitting on each segment to obtain a shape parameter of each segment. The shape parameter includes the center of the polygonal prism, and the size, height, and center line direction according to the shape. For example, the segment correction unit 221 re-groups, into one segment, segments each having the angle of the obtained center line direction of the polygonal prism within the predetermined range.

Note that, for example, random sample consensus (RANSAC) that is a robust parameter estimation method is applicable to the various shape fittings described here. Furthermore, for example, as the center line used when a distance between the center lines of the shape parameters is evaluated, a line segment obtained by extending, in the object region, the center line obtained as a result of shape fitting is used.

The segment correction unit 221 assigns, to each corrected segment of the three-dimensional object point cloud, object type information indicating the type of the object recognized by the object detection processing. The segment correction unit 221 supplies, to the shape recognition unit 124, three-dimensional object point cloud data containing the corrected segment information.

Then, the processing proceeds to step S407.

On the other hand, in step S405, in a case where the plurality of segments does not correspond to the same object region, the segment correction unit 221 determines that there is no segment as a correction candidate. The segment correction unit 221 supplies, to the shape recognition unit 124, the three-dimensional object point cloud data supplied from the integration unit 123 as it is. Then, step S406 is skipped, and the processing proceeds to step S407.

In steps S407 and S408, processes similar to steps S105 and S106 in FIG. 7 are executed.

Then, the object detection processing ends.

As described above, it is possible to improve the accuracy of the correction of the segment of the three-dimensional object point cloud as compared to the third embodiment.

### Fourth Embodiment of Object Detection Processing

In a fourth embodiment of the object detection processing, ranging points corresponding to a transparent region or a reflective region of the object are extracted from the three-dimensional object point cloud. Then, on the basis of the extracted ranging points, ranging points corresponding to a surface region of the object corresponding to the transparent region or the reflective region (hereinafter, referred to as object surface region) are interpolated, and the shape of the object is recognized on the basis of the interpolated three-dimensional object point cloud.

Here, the transparent region is a region that can be seen through the surface of the object, and is a region that is originally obstructed by the object surface region and cannot be seen. The reflective region is a specularly reflective region of the surface of the object. The object surface region corresponding to the transparent region is a region of the surface of the object coincident with the transparent region as viewed from the ranging unit 11, and the transparent region can be seen through the region of the surface of the object from the ranging unit 11. The surface region corresponding to the reflective region is a region of the surface of the object where the reflective region exists.

Note that the transparent region and the reflective region are collectively referred to as transparent/reflective region below.

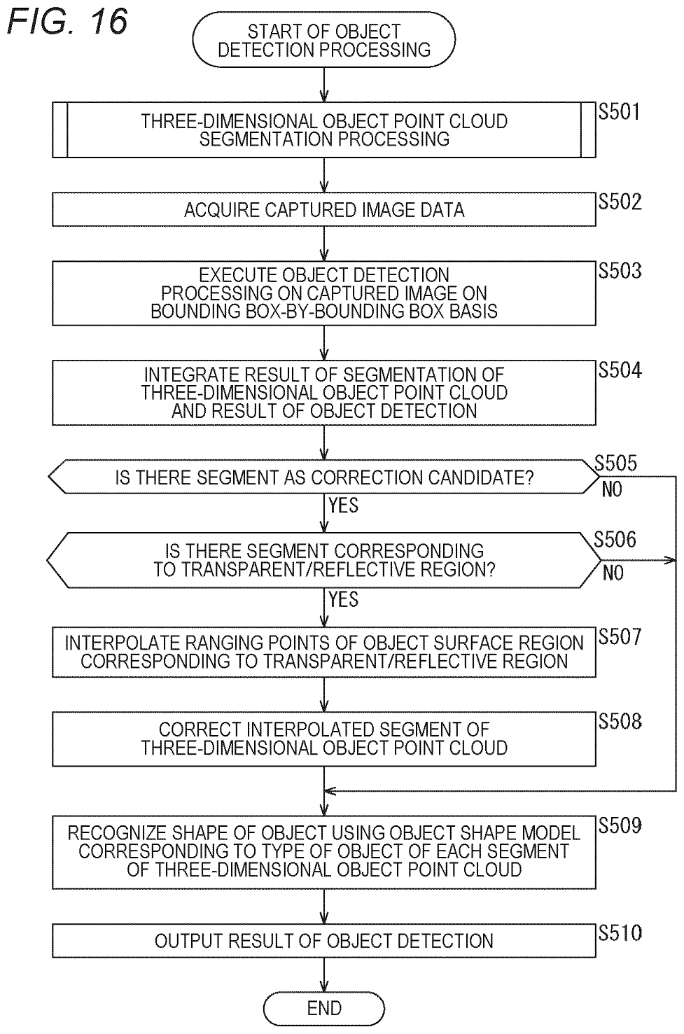

The fourth embodiment of the object detection processing executed by the information processing system 201 will be described below with reference to the flowchart in FIG. 16.

In steps S501 to S504, processes similar to steps S301 to S304 in FIG. 12 are executed.

In step S505, whether or not there is a segment as a correction candidate is determined in a manner similar to the process of step S405 in FIG. 14. In a case where it is determined that there is a segment as a correction candidate, the processing proceeds to step S506.

In step S506, the segment correction unit 221 determines whether or not there is a segment corresponding to the transparent/reflective region.

For example, the segment correction unit 221 selects one of the segments as correction candidates, and compares a distance of the selected segment with a distance of a neighboring segment. For example, the segment correction unit 221 sets a mean value of the distance values of the ranging points of the selected segment as the distance of the selected segment, and sets a mean value of the distance values of the ranging points of the neighboring segment as the distance of the neighboring segment.

In a case where there is no neighboring segment smaller in distance than the selected segment, the segment correction unit 221 determines that the selected segment corresponds to the object surface region of the object. On the other hand, in a case where there is a neighboring segment smaller in distance than the selected segment, the segment correction unit 221 determines that the selected segment corresponds to the transparent/reflective region.

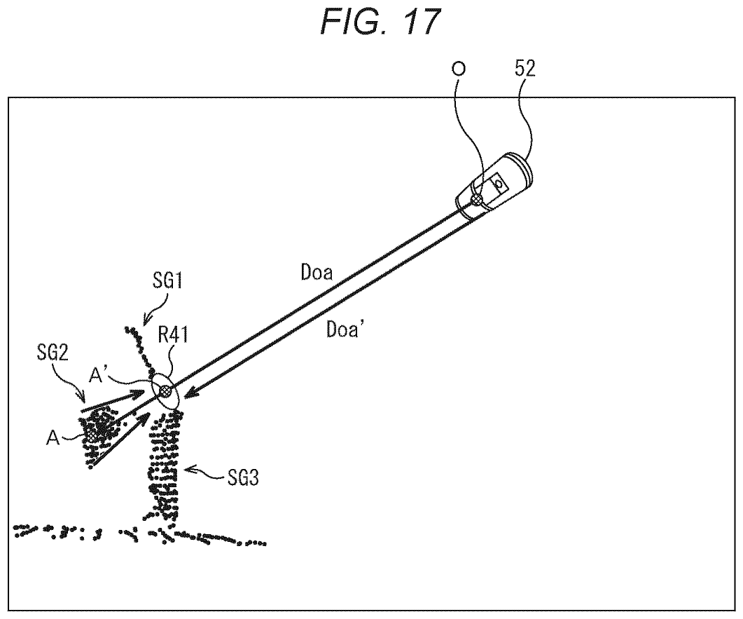

FIG. 17 illustrates, as in FIG. 5, a positional relationship among the segments SG1 to SG3 of the point cloud corresponding to the plastic bottle 51. In this case, the segment SG1 is closer to an optical center O of the ranging sensor 52 than the neighboring segment SG2, so that the segment SG1 is determined to correspond to the object surface region. The segment SG3 is closer to the optical center O of the ranging sensor 52 than the neighboring segment SG2, the segment SG3 is determined to correspond to the object surface region. On the other hand, the segment SG2 is farther from the optical center O of the ranging sensor 52 than the neighboring segments SG1 and SG3, the segment SG2 is determined to correspond to the transparent/reflective region.

Note that, for example, in a case where the bottom of the object is transparent, it is assumed that an installation surface such as a floor or a table is directly observed through the transparent region. In this case, by the above-described method, the transparent region in contact with the installation surface is not correctly detected.

On the other hand, the segment correction unit 221 executes determination as to whether or not the region of the object adjacent to the installation surface is in contact with the installation surface. Specifically, the segment correction unit 221 detects, among the segments as correction candidates, a segment corresponding to the object surface region located at the lowermost level in the gravity direction in the corresponding object region. The segment correction unit 221 scans the ranging points in the gravity direction from the lower side of the object surface region corresponding to the detected segment toward the installation surface region in the range image. The segment correction unit 221 determines that the object is in contact with the ground in a case where the ranging points have almost no change in distance from the object surface region to the installation surface region. On the other hand, in a case where the ranging points become larger in distance from the object surface region to a floor surface region, the segment correction unit 221 determines that it is not in contact with the ground, that is, the transparent region is included.

In a case where the segment correction unit 221 determines that the transparent region is included, the segment correction unit 221 sets, as the transparent region, a range from a boundary where the distance becomes larger in accordance with transition from the object surface region to the installation surface region to a boundary where the distance of the installation surface region becomes the same as the distance of the object surface region.

Note that the gravity direction on the range image can be obtained, for example, by projecting a gravity direction detected using a sensor such as an inertial measurement unit (IMU) onto the range image with the orientation of the ranging sensor 52 relative to the gravity direction taken into account.

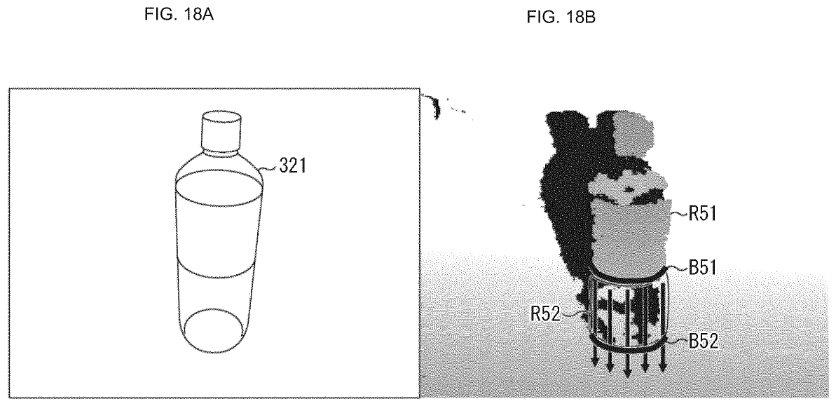

For example, B of FIG. 18 illustrates an example of a range image for a plastic bottle 321 schematically illustrated in A of FIG. 18.

In this case, an object surface region R51 is the lowermost object surface region in the gravity direction in the object region corresponding to the plastic bottle 321. Then, the ranging points are scanned in the gravity direction from a lower side B51 of the object surface region R51 toward the installation surface region. As a result, a boundary B52 at which the distance of the installation surface region becomes the same as the distance of the object surface region is detected. Then, a region R52 between the boundary B51 and the boundary B52 is detected as the transparent region.

Next, the segment correction unit 221 interpolates the ranging points in the object surface region (hereinafter, referred to as interpolation target surface region) corresponding to the segment corresponding to the transparent/reflective region (hereinafter, referred to as transparent/reflective segment).

Specifically, for each ranging point belonging to the transparent/reflective segment, the segment correction unit 221 interpolates the ranging points in the interpolation target surface region on the basis of on the ranging points belonging to the segment corresponding to the neighboring object surface region (hereinafter, referred to as object surface segment).

For example, for a ranging point A belonging to the segment SG2 that is the transparent/reflective segment in FIG. 17, a ranging point A′ in an interpolation target surface region R41 corresponding to the segment SG2 is interpolated on the basis of the ranging points belonging to the segment SG1 and the segment SG3 that are the neighboring object surface segments.

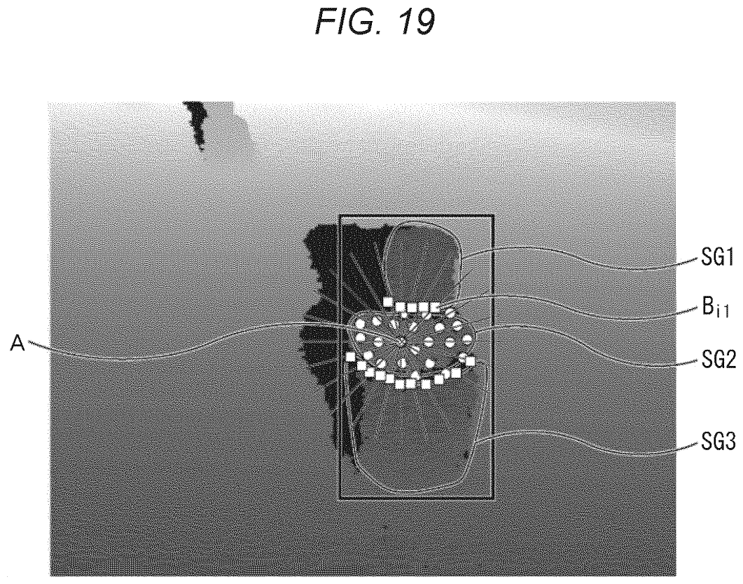

Here, a specific example of a ranging point interpolation method will be described with reference to FIGS. 19 to 21.

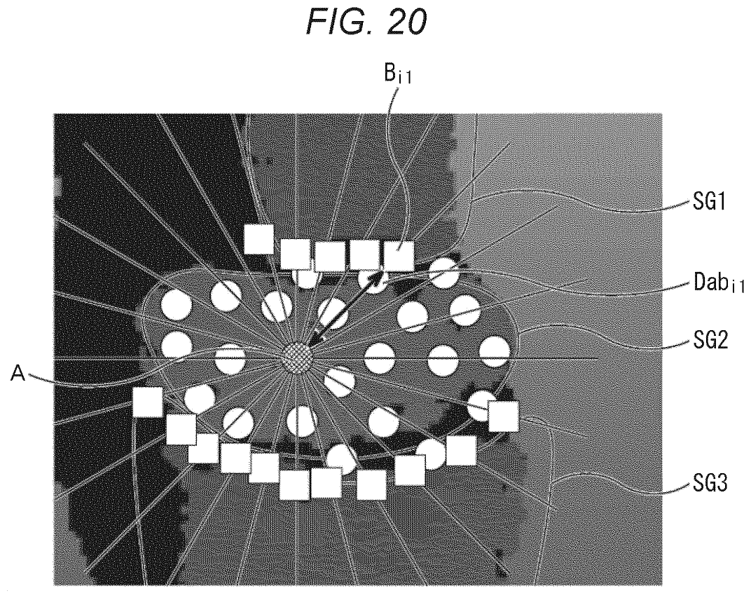

FIG. 19 schematically illustrates ranging points located adjacent to the segment SG2 among the ranging points belonging to the segment SG1 and the segment SG3, and ranging points belonging to the segment SG2. FIG. 20 is an enlarged view of the segment SG2 in FIG. 19 and the periphery of the segment SG2.

For example, the segment correction unit 221 searches the captured image on which each ranging point is projected for the nearest neighboring point nearest to the ranging point A belonging to the segment SG2 among the ranging points belonging to the segment SG1 and the ranging points belonging to the segment SG3.

Specifically, the segment correction unit 221 rotates a straight line Li (i=1, 2, . . . , N) passing through the ranging point A by 360/N degrees around the ranging point A in the captured image on which each ranging point is projected. Here, among ranging points of the segment SG1 located on the straight line Li, the ranging point nearest to the ranging point A is denoted as Bᵢ₁. Among ranging points of the segment SG3 located on the straight line Li, the ranging point nearest to the ranging point A is denoted as Bᵢ₃.

Then, the segment correction unit 221 searches for a combination of the ranging point Bᵢ₁ and the ranging point Bis satisfying the following Formula (3).

$$\begin{matrix}[ Math . 3 ] & \\ i = arg {min}_{i} ( {Dab}_{i 1} + {Dab}_{i 3} ) & ( 3 )\end{matrix}$$

Note that Dabᵢ₁ denotes a distance between the ranging point A and the ranging point Bᵢ₁ in the coordinate system of the captured image. Dabᵢ₃ denotes a distance between the ranging point A and the ranging point Bᵢ₃ in the coordinate system of the captured image. That is, the segment correction unit 221 searches for a combination of the ranging point Bᵢ₁ and the ranging point Bis where the sum of the distance Dabᵢ₁ and the distance Dabᵢ₃ is the smallest.

Next, the segment correction unit 221 calculates a vector OA′ from the optical center O of the ranging sensor 52 to the ranging point A′ using the following Formula (4).

$$\begin{matrix}[ Math . 4 ] & \\ \vec{OA} ’ = \frac{{Dab}_{i 3} \vec{{OB}_{i 1}} + {Dab}_{i 1} \vec{{OB}_{i 3}}}{{Dab}_{i 1} + {Dab}_{i 3}} & ( 4 )\end{matrix}$$

Therefore, the ranging point A′ is an internal division point between the ranging point Bᵢ₁ and the ranging point Bᵢ₁ in the three-dimensional space. Then, the ranging point A′ is an interpolation point in the interpolation target surface region R41 corresponding to the ranging point A.

Note that, for example, in a case where the transparent/reflective segment is located at an end of the object region and there is only one neighboring segment, there is a possibility that an intersection of the straight line Li and a ranging point of the neighboring segment is located only on one side of the straight line Li relative to the ranging point A.

In this case, the segment correction unit 221 executes function approximation using a function representing a relationship between the position on the straight line Li of the ranging point located on the straight line Li in the neighboring segment and the distance value. Then, the segment correction unit 221 obtains, on the basis of a derived approximate curve, a distance value Doa′ in the three-dimensional space of the ranging point A′ corresponding to the ranging point A in the range image by extrapolation.

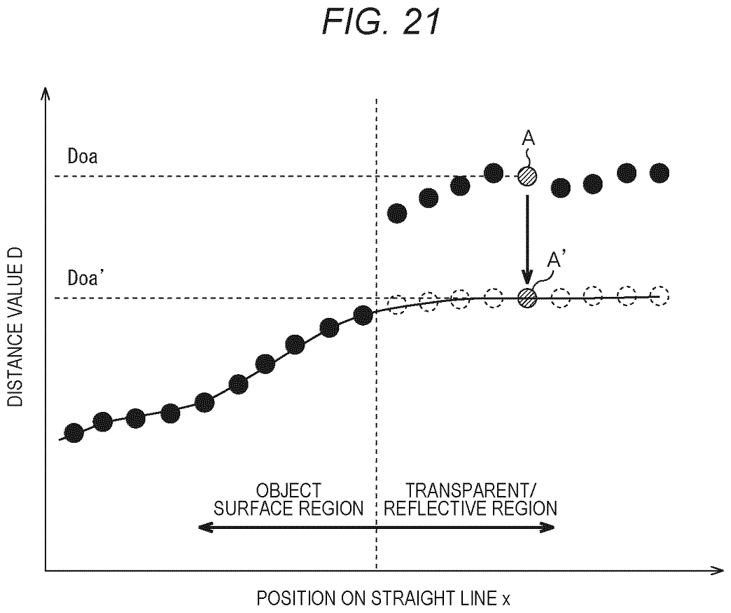

For example, FIG. 21 is a graph showing an example of the relationship between the position of the ranging point on the straight line Li and the distance value in the neighboring object surface region (object surface segment) and transparent/reflective region (transparent/reflective segment). The horizontal axis indicates the position of the ranging point on the straight line Li, and the vertical axis indicates the distance value of each ranging point.

In this example, the distance value of the ranging point in the interpolation target surface region corresponding to the ranging point on the straight line Li in the transparent/reflective region is calculated by function approximation using a curve representing the relationship between the position of the ranging point on the straight line Li in the object surface region and the distance value. For example, in a case where the distance value of the ranging point A is Doa, the distance value Doa′ of the ranging point A′ of the interpolation target surface region corresponding to the ranging point A is calculated by function approximation.

Note that FIG. 17 illustrates a relationship between the distance value Doa and the distance value Doa′.

Moreover, the segment correction unit 221 obtains the virtual ranging point A′ using the following Formula (5).

$$\begin{matrix}[ Math . 5 ] & \\ \vec{OA} ’ = \frac{Doa ’}{Doa} \vec{OA} & ( 5 )\end{matrix}$$

The segment correction unit 221 executes the above-described processing for all the ranging points belonging to the transparent/reflective segment to update all the ranging points belonging to the transparent/reflective segment to the interpolated ranging points.

Note that, depending on the transparent/reflective region, there is a possibility that the ranging sensor 52 does not operate normally, and a region where no ranging point exists or a region where a distance value is indefinite occurs. In this case, for example, instead of the actually observed ranging points, sampling points may be uniformly generated in a grid shape and regarded as the ranging points in the transparent/reflective region, and similar processing may be executed.

Returning to FIG. 16, in step S508, the segment correction unit 221 corrects the interpolated segment of the three-dimensional object point cloud. For example, the segment correction unit 221 generates one segment by grouping the segment corresponding to the object surface region among the segments as correction candidates corresponding to the same object region and the segment including the ranging points interpolated on the basis of the ranging points belonging to the segment corresponding to the transparent/reflective region.

Then, the processing proceeds to step S509.

On the other hand, in a case where it is determined in step S506 that there is no segment corresponding to the transparent/reflective region, steps S507 and S508 are skipped, and the processing proceeds to step S509.

Furthermore, in a case where it is determined in step S505 that there is no segment as a correction candidate, steps S506 to S508 are skipped, and the processing proceeds to step S509.

In steps S509 and S510, processes similar to steps S105 and S106 in FIG. 7 are executed.

Then, the object detection processing ends.

As described above, even if the ranging points to be obtained from the original object surface are not detected due to light transmission or reflection, it is possible to improve the object detection accuracy.

### 4. Modifications

Hereinafter, modifications of the above-described embodiments of the present technology will be described.

For example, in the third embodiment of the object detection processing, segments within a certain distance in the depth direction as viewed from the ranging sensor may be re-grouped without using the geometric constraint condition such as shape fitting.

In the above description, a plastic bottle whose surface is partially transparent has been given as an example of the object to be detected, but in the present technology, the type of the object is not particularly limited, and the present technology can be applied to any case where an object having a transparent surface or a specularly reflective surface is detected.

For example, in a case where a transparent box-shaped package is detected, there is a possibility that contents in the package are detected, or the surface of the package exhibits specular reflection and is partially lost accordingly, but the use of the present technology allows accurate detection of such a box-shaped package.

### 5. Others

### <Configuration Example of Computer>

The above-described series of processing can be executed by hardware or software. In a case where the series of processing is executed by software, a program constituting the software is installed in a computer. Here, examples of the computer include a computer incorporated in dedicated hardware, and for example, a general-purpose personal computer that can execute various functions with various programs installed on the general-purpose personal computer.

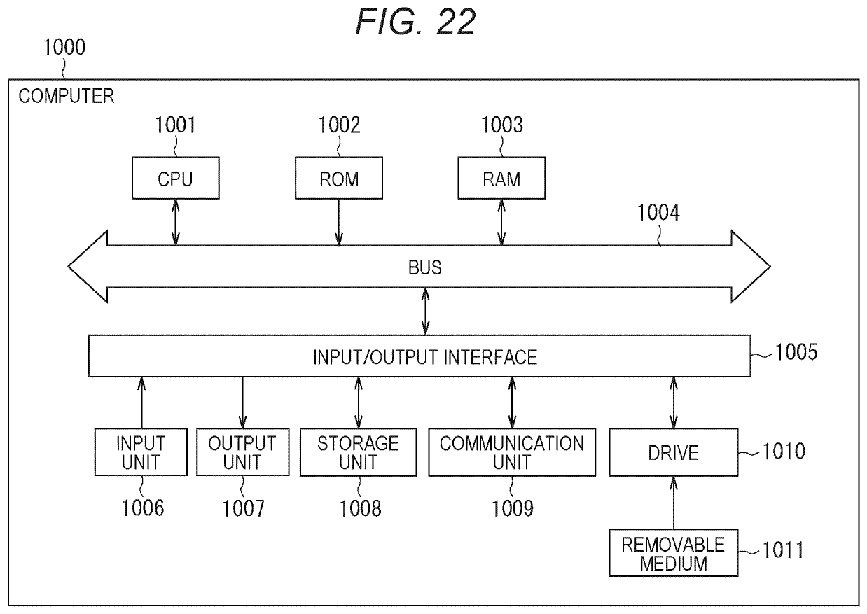

FIG. 22 is a block diagram illustrating a configuration example of hardware of a computer that executes the above-described series of processing in accordance with a program.

In a computer 1000, a central processing unit (CPU) 1001, a read only memory (ROM) 1002, and a random access memory (RAM) 1003 are interconnected via a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an imaging element, and the like. The output unit 1007 includes a display, a speaker, and the like. The storage unit 1008 includes a hard disk, a non-volatile memory, and the like. The communication unit 1009 includes a network interface and the like. The drive 1010 drives a removable medium 1011 such as a magnetic disk, an optical disc, a magneto-optical disk, or a semiconductor memory.

In the computer 1000 configured as described above, the series of processing described above is executed, for example, by the CPU 1001 loading a program stored in the storage unit 1008 into the RAM 1003 via the input/output interface 1005 and the bus 1004, and executing the program.

The program executed by the computer 1000 (CPU 1001) can be provided, for example, by being recorded in the removable medium 1011 as a package medium and the like. Furthermore, the program can be provided via a wired or wireless transmission medium such as a local area network, the Internet, or digital satellite broadcasting.

In the computer 1000, by attaching the removable medium 1011 to the drive 1010, the program can be installed in the storage unit 1008 via the input/output interface 1005. Furthermore, the program can be received by the communication unit 1009 via a wired or wireless transmission medium and installed in the storage unit 1008. Alternatively, the program can be preinstalled in the ROM 1002 or the storage unit 1008.

Note that the program executed by the computer may be a program that executes processing in time series in the order described in the present specification, or a program that executes processing in parallel or at a necessary timing such as when a call is made.

Furthermore, in the present specification, a system means an assembly of a plurality of components (devices, modules (parts), and the like), and it does not matter whether or not all the components are in the same casing. Therefore, a plurality of devices housed in separate casings and connected via a network and one device in which a plurality of modules is housed in one casing are both systems.

Moreover, the embodiments of the present technology are not limited to the above-described embodiments, and various modifications can be made without departing from the gist of the present technology.

For example, the present technology may be configured as cloud computing in which one function is shared by a plurality of devices via the network to process together.

Furthermore, each step described in the above-described flowcharts may be executed by one device or executed by a plurality of devices in a shared manner.

Moreover, in a case where a plurality of processes is included in one step, the plurality of processes included in one step may be executed by one device or by a plurality of devices in a shared manner.

### <Example of Configuration Combination>

The present technology may also have the following configurations.

(1)

An information processing device including:
a segmentation unit that executes segmentation of a first point cloud including a plurality of ranging points on the basis of a distance between the ranging points to partition the first point cloud into a plurality of segments;
an object detection unit that executes object detection processing on the basis of a captured image obtained by capturing an image of an observation region where the first point cloud has been observed; and
a segment correction unit that corrects the segments on the basis of a result of the object detection processing.
   (2)

The information processing device according to the above (1), in which
the object detection unit detects an object region where an object appears in the captured image, and
the segment correction unit groups, into a same segment, the ranging points corresponding to the same object region but belonging to the different segments.
   (3)

The information processing device according to the above (2), in which
the object detection unit recognizes a type of an object in the object region, the information processing device further including a shape recognition unit that recognizes a shape of an object corresponding to each of the segments using an object shape model corresponding to a type of the object corresponding to the segment.
   (4)

The information processing device according to the above (2) or (3), in which
the object detection unit detects the object region having a rectangular shape.
   (5)

The information processing device according to the above (4), in which
the segment correction unit groups, into one segment, a plurality of the segments corresponding to the same object region.
   (6)

The information processing device according to the above (4), in which
the segment correction unit groups, into one segment, a plurality of the segments corresponding to the same object region in a case where a plurality of the segments satisfies a geometric constraint condition.
   (7)

The information processing device according to the above (4), in which
in a case where there is the segment corresponding to a transparent region or a reflective region of an object among a plurality of the segments corresponding to the same object region, the segment correction unit interpolates the ranging points in a surface region of the object corresponding to the transparent region or the reflective region, and groups, into one segment, the segment corresponding to the surface region of the object among a plurality of the segments and the segment including the ranging points that have been interpolated.
   (8)

The information processing device according to the above (7), in which
the transparent region is a region that is seen through a transparent portion of a surface of the object, and
the reflective region is a region of the surface of the object that exhibits specular reflection.
   (9)

The information processing device according to the above (2) or (3), in which
the object detection unit executes semantic segmentation on the captured image.
   (10)

The information processing device according to any one of the above (1) to (9), further including a point cloud extraction unit that generates the first point cloud including the ranging points corresponding to a three-dimensional object by removing the ranging points corresponding to a plane from a second point cloud generated on the basis of a range image indicating distance values of the ranging points in the observation region.

(11)

An information processing method including:
executing segmentation of a point cloud including a plurality of ranging points on the basis of a distance between the ranging points to partition the point cloud into a plurality of segments;
executing object detection processing on the basis of a captured image obtained by capturing an image of an observation region where the point cloud has been observed; and
correcting the segments on the basis of a result of the object detection processing.

Note that the effects described in the present specification are merely examples and are not limited, and other effects may be achieved.

### REFERENCE SIGNS LIST

11 Ranging unit
21, 22 Resampling unit
23 Plane point cloud extraction unit
24 Three-dimensional object point cloud extraction unit
25 Segmentation unit
111 Image acquisition unit
121 Object detection unit
123 Integration unit
124 Shape recognition unit
201 Information processing system
211 Information processing unit
221 Segment correction unit

1. An information processing device comprising:
a segmentation unit that executes segmentation of a first point cloud including a plurality of ranging points on a basis of a distance between the ranging points to partition the first point cloud into a plurality of segments;
an object detection unit that executes object detection processing on a basis of a captured image obtained by capturing an image of an observation region where the first point cloud has been observed; and
a segment correction unit that corrects the segments on a basis of a result of the object detection processing.

2. The information processing device according to claim 1, wherein
the object detection unit detects an object region where an object appears in the captured image, and
the segment correction unit groups, into a same segment, the ranging points corresponding to the same object region but belonging to the different segments.

3. The information processing device according to claim 2, wherein
the object detection unit recognizes a type of an object in the object region, the information processing device further comprising a shape recognition unit that recognizes a shape of an object corresponding to each of the segments using an object shape model corresponding to a type of the object corresponding to the segment.

4. The information processing device according to claim 2, wherein
the object detection unit detects the object region having a rectangular shape.

5. The information processing device according to claim 4, wherein
the segment correction unit groups, into one segment, a plurality of the segments corresponding to the same object region.

6. The information processing device according to claim 4, wherein
the segment correction unit groups, into one segment, a plurality of the segments corresponding to the same object region in a case where a plurality of the segments satisfies a geometric constraint condition.

7. The information processing device according to claim 4, wherein
in a case where there is the segment corresponding to a transparent region or a reflective region of an object among a plurality of the segments corresponding to the same object region, the segment correction unit interpolates the ranging points in a surface region of the object corresponding to the transparent region or the reflective region, and groups, into one segment, the segment corresponding to the surface region of the object among a plurality of the segments and the segment including the ranging points that have been interpolated.

8. The information processing device according to claim 7, wherein
the transparent region is a region that is seen through a transparent portion of a surface of the object, and
the reflective region is a region of the surface of the object that exhibits specular reflection.

9. The information processing device according to claim 2, wherein
the object detection unit executes semantic segmentation on the captured image.

10. The information processing device according to claim 1, further comprising a point cloud extraction unit that generates the first point cloud including the ranging points corresponding to a three-dimensional object by removing the ranging points corresponding to a plane from a second point cloud generated on a basis of a range image indicating distance values of the ranging points in the observation region.

11. An information processing method comprising:
executing segmentation of a point cloud including a plurality of ranging points on a basis of a distance between the ranging points to partition the point cloud into a plurality of segments;
executing object detection processing on a basis of a captured image obtained by capturing an image of an observation region where the point cloud has been observed; and
correcting the segments on a basis of a result of the object detection processing.
